(19) United States
(12) Patent Application Publication
(10) Pub. No.: US 2007/0191973 A1
(43) Pub. Date: Aug. 16, 2007

(54) Apparatus and method for configuring, processing and viewing state based data

(75) Inventors: Bryan Holzbauer, Gardnerville, NV (US); Ken Ceglia, Gardnerville, NV (US); Wayne Johnson JR., Gardnerville, NV (US); Scott Williams, Minden, NV (US); Richard Gomer, Carson City, NV (US)

Correspondence Address: NIXON & VANDERHYE, PC, 901 NORTH GLEBE ROAD, 11TH FLOOR, ARLINGTON, VA, 22203, US

(73) Assignee: General Electric Company, Schenectady, NY (US)

(21) Appl. No.: 11/350,768

(22) Filed: Feb. 10, 2006

(51) Int. Cl. G05B 9/02; G05B 11/01; G08B 21/00

(52) U.S. Cl. 700/80; 700/17; 340/679

(57) ABSTRACT

This invention allows users to set different alarm conditions and data storage criteria for multiple data points based on the operating modes (states) of their machinery. The users will also be able to selectively view the collected data based on the machinery states.

### FIELD OF THE INVENTION

The present invention relates generally to a system and method for enabling or disabling data storage for data points related to heavy machinery and, in particular, to machine trains such as, for example, hydro turbine generator plants.

### BACKGROUND OF THE INVENTION

Current software suites have functionality that allows users to turn on and off data storage for a set of data points based on the value from a single state variable. If the state variable indicates that the state is “in state,” then data is stored. If the state variable indicates that the state is “out of state,” then data is not stored.

Still other software has functionality that allows the user to configure data storage and alarming for data points for 3 specific states (online, offline, and steady state). The prior art software, however, only allows the user to make configuration changes at a single point rather than at multiple points using the concept of state based child points. With the prior art software the user also does not have the option to filter the data to only show the data that was collected for a specific state.

Currently, there are situations where users want to be able to configure different alarm conditions and data storage criteria based on the operating modes (or states) of their machinery. The users also want to be able to view data based on these operating modes.

### BRIEF SUMMARY OF THE INVENTION

An objective of this invention is to allow the user to configure different sets of alarm setpoints and data storage criteria based on the state of a machine (e.g. pump, generate, synchronous condense, off).

The present invention provides a method for configuring multiple data points that collectively relate to the components of a machine train, acquiring data at particular component points and operating states, and providing display functionality of the machine train components and data points.

The configuration of data points for state based data processing involves using a parent data point configured with state based data points configured under it. Each of the state based child points is linked to a node that defines the logic for the state. The state based child points will have the full configuration of the parent points so that the user can change the configuration properties for each child point. Examples of configuration properties include: machinery rotation direction, point names, alarm setpoints, and data storage criteria (e.g. only store data if the value changes, etc). For example, the user can define the rotation direction differently for the state based points if the machinery can rotate in different directions (as with Hydro power plants where the machinery rotates in one direction while generating power, and the reverse direction while pumping water back up into the reservoir).

The data acquisition process involves storing the collected data using the configuration information from the state based data points. In all cases, the system software stores the data at the parent point, by using a combination of data storage criteria from the parent point and the state based child points. The system software only uses the configuration information from the state based data points when the associated state logic evaluates that the state is “in state.” When the state logic for state based data points evaluate such that the state is “out of state,” the system software will stop using the configuration information for these state based points. Examples of configuration values that will be processed during the processing & storage of incoming data include: alarm setpoints and data storage criteria.

The display functionality allows the user to use the state based data points to view the data in a Display client for the time periods when the machinery was operating in the associated state.

Prior art systems and methods created new state based points where data was stored when “in state” and not stored when “out of state.” Therefore, advantages gained by the present invention include, but are not limited to, the following:
Enables overlapping states without duplicate data storage.
Stores data in a single higher-level source point that can be viewed without state filters.
Maintains the ability to configure overall alarm values applied independent of state.

### BRIEF DESCRIPTION OF THE DRAWINGS

FIGS. 1A, 1B, and 1C, respectively represent a flow chart showing the operation of the system software; a flow chart of the data acquisition data flow in the system software; and a flow chart of the data acquisition state change processing in the system software;

FIG. 2 illustrates configuring the data points and the machinery in the configuration software;

FIG. 3 illustrates defining the logic for each state of the machinery;

FIG. 4 illustrates how the state qualified variables of FIG. 3 are configured;

FIG. 5 shows a dialog box for configuring the state indicator to define the name and association with the state qualified variable;

FIG. 6 shows how the points that are to be associated with a particular state indicator are selected;

FIG. 7 shows how to add, and remove various associations with other nodes in the configuration trees;

FIG. 8 shows how to create custom user-defined properties for the state indicators;

FIG. 9 shows an example of how state-enabled points are configured;

FIG. 10 shows a menu for state-enabled points;

FIG. 11 shows the configuration properties dialog for the state-enabled points;

FIG. 12 illustrates configuring set points for either the parent point or the child state-enabled points;

FIG. 13 illustrates configuring in-band alarm set points for either the parent point or the child state-enabled points;

FIG. 14 illustrates configuring out-of-band alarm set points for either the parent point or the child state-enabled points;

FIG. 15 shows a dialog box for configuring acceptance region set points for either the parent point or the child state-enabled points;

FIG. 16 shows a configuration dialog for configuring the change filtering data storage parameters for either the parent point or the child state-enabled points;

FIG. 17 shows an example of a hydro turbine/generator, machine train in the high temperature state;

FIG. 18 illustrates allowing the user to display filtered data plots for the state-enabled points;

FIG. 19 shows a schematic block diagram of an exemplary embodiment of the present invention; and

FIG. 20 shows an example of in state and out of state data processing of data points related to a machine train.

### DETAILED DESCRIPTION OF THE INVENTION

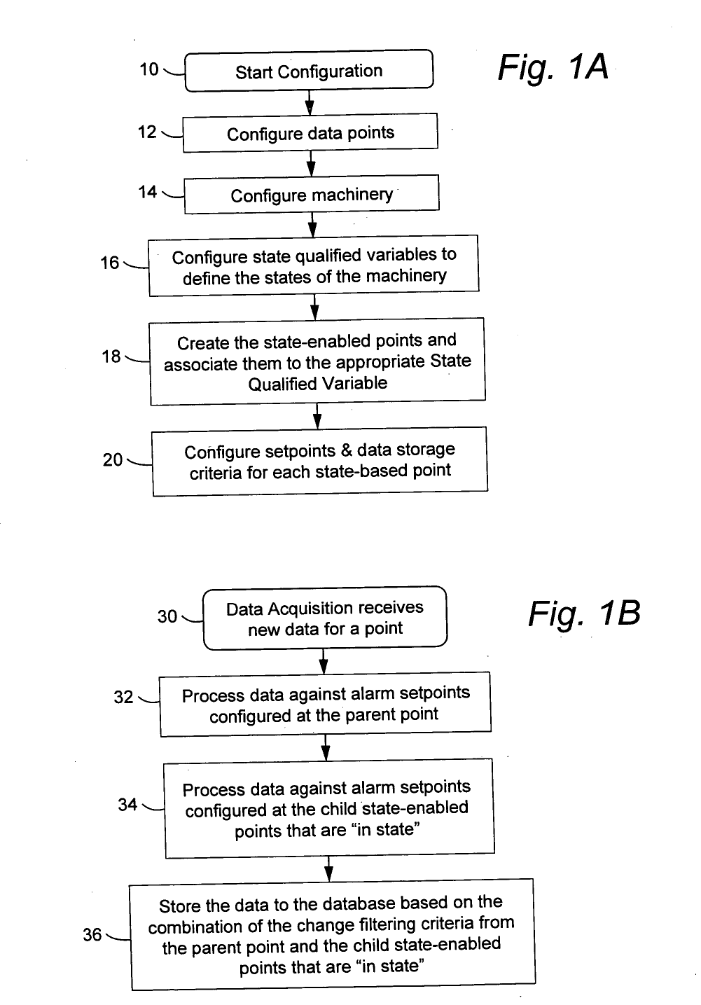

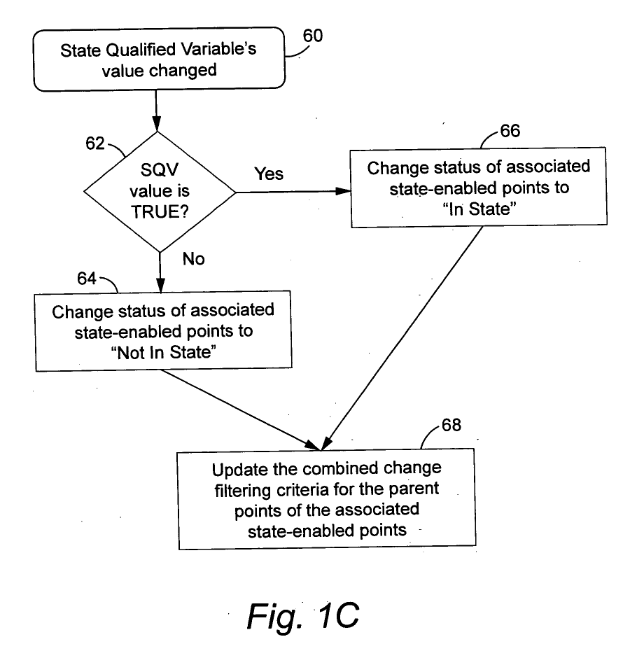

Flow charts illustrating the operation of the inventive system software are provided by FIGS. 1A, 1B and 1C. More particularly, FIG. 1A is a flow chart of the configuration of state-enabled system software and starts at block 10. At block 12 the data points are configured. At block 14 the machinery is configured. As shown in block 16 the configuration of state qualified variables to define the machinery states is performed. In block 18 state-enabled points are created and associated with appropriate state qualified variables. Finally, in block 20 the set points and data storage criteria for each state-based point are configured.

FIG. 1B shows the data acquisition flow chart for the inventive system software. In particular, in block 30 data is received for a point. In block 32 the data is processed against alarm set points configured at the parent point. In block 34 the data is processed against alarm set points configured at the child state-enabled point that are “in state.” Finally, in block 36 the data is stored in the database based on the combination of change filtering criteria from the parent point and the child state-enabled points that are “in state.”

FIG. 1C shows a flow chart for the data acquisition state change processing portion of the inventive system software. More particularly, in block 60 a state qualified variables value is changed. In state 62 it is determined whether the value is true or false. If true, the flow chart proceeds to block 66 where a change status of associated state-enabled points to “in state” is performed. If in block 62 the value is false, then the flow chart proceeds to block 64 where a change status of associated state-enabled point to “not in state” is performed. Finally, both blocks 64 and 66 lead to block 68 where the combined change filtering criteria for the parent points of the associated state-enabled points are updated.

FIG. 19 shows an exemplary embodiment of the system component for the present invention. As shown in FIG. 19, data sources provide data to a data acquisition server which is connected in a LAN system to a number of other servers and stations. For example, there is a database server also connected to the LAN which accesses a configuration database and a historical data database. In FIG. 19 two different types of data acquisition servers are shown, one which receives inputs from data sources such as sensors or transducers located at pertinent points in the machine trains (not shown) and a data acquisition server which receives data from a process data server. Also shown connected to the LAN in FIG. 19 is a display station, a display and configuration station and a configuration station. As will be well understood by those skilled in the art, the system can also be implemented by a single server performing all of the functions identified in FIG. 19 and with a single display and configuration station for operating the inventive system software.

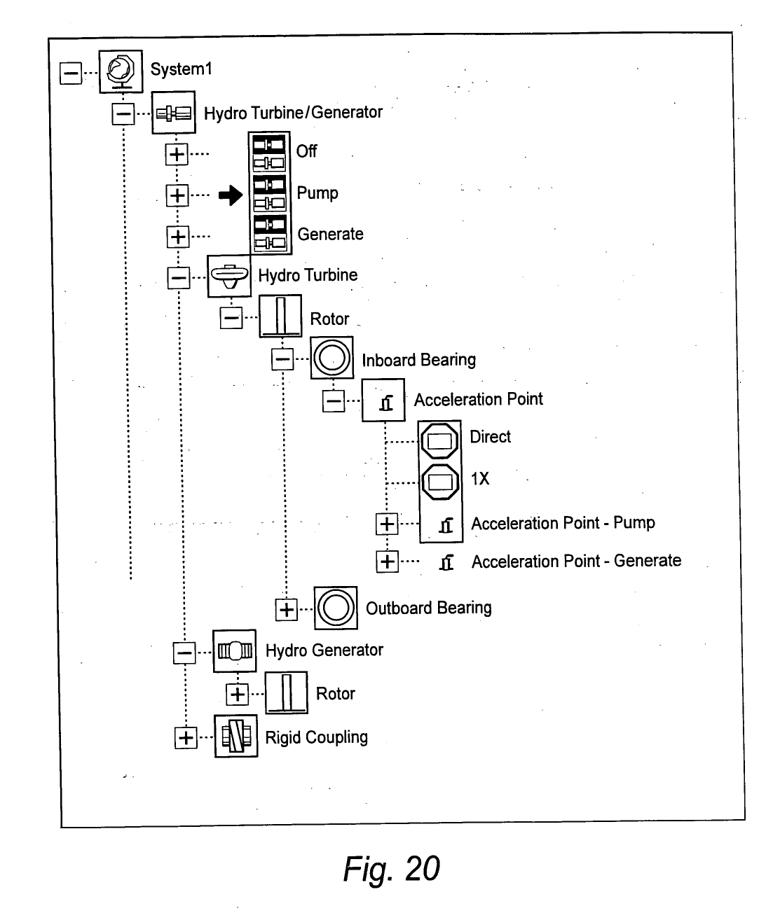

An overview of the configuration system software which gives a user the ability to configure state based points beneath parent points and associate these state based points with logic that defines the operating state will now be described. As shown in FIG. 20, the point named “Acceleration Point” has two variables (namely “Direct” and “1X”) and two state based child points (“Acceleration Point—Pump” and “Acceleration Point—Generate”) under the parent point. The state based child points are linked with a state value (i.e. the “Acceleration Point—Pump” point is linked to the “Pump” state and the “Acceleration Point—Generate” point is linked to the “Generate” state. The user has the ability to make changes to the configuration of these state enabled child points. The configuration information at the state based child points is only used when the associated state value indicates that the state is “in state.” However, those skilled in the art will readily recognize that the present invention is not restricted to a tree based implementation as is shown in FIG. 20.

The data acquisition software stores all of the collected data at the parent point using the combination of the data storage criteria from the parent point and the child state based points that are “in” their associated states. When the values of the states change, the data storage criteria will also change to include the data storage criteria from the state based points that just went in to their associated states (and stop using the data storage criteria from the state based points that just went out of their associated states). Any other configuration properties that are related to data processing and storage (e.g. alarm setpoints, data storage criteria) that are configured at the state based child points will also be used only when the associated state is “in state.” The data acquisition software will also provide online state filtered data to external data consumers (e.g. display clients, data exporters, outside data servers) at the state based child points.

For the example shown in FIG. 20 the “Pump” state is “in state” and the “Generate” and “Off” states are “out of state”, so the data processing related configuration parameters configured under the “Acceleration Point—Pump” point will be used and those under the “Acceleration Point—Generate” point will not be used. A heavy lined box around the icons in FIG. 20 indicates that the point associated with the icon is “in state.” A preferred way to show the “in state” points as compared to the “out of state” points is by color coding, e.g., green for “in state” and no color (or white background) for “out of state.”

The display software will allow the user to view the state based data using the child state based points. The user will be able to see live current data values as well as historical data values using the child state based points. The user will also be able to visually see which of the state based points are in their associated state. In the example shown in FIG. 20, the “Acceleration Point—Pump” point is shown as being in its associated state, while the “Acceleration Point—Generate” point is not in its associated state.

In the preferred embodiment, if the user opens a plot for a child state-enabled point that is “Not In State,” the plot will show “No Data” indicating that the point has not received a data sample. Alternatively, the software can operate so that if the user opens a current values plot for a state based point that is in its associated state, the plot will show the current data values.

If the user opens a historical data plot for a state based point, only the data that was collected while the associated state was “in state” will be shown in the plot.

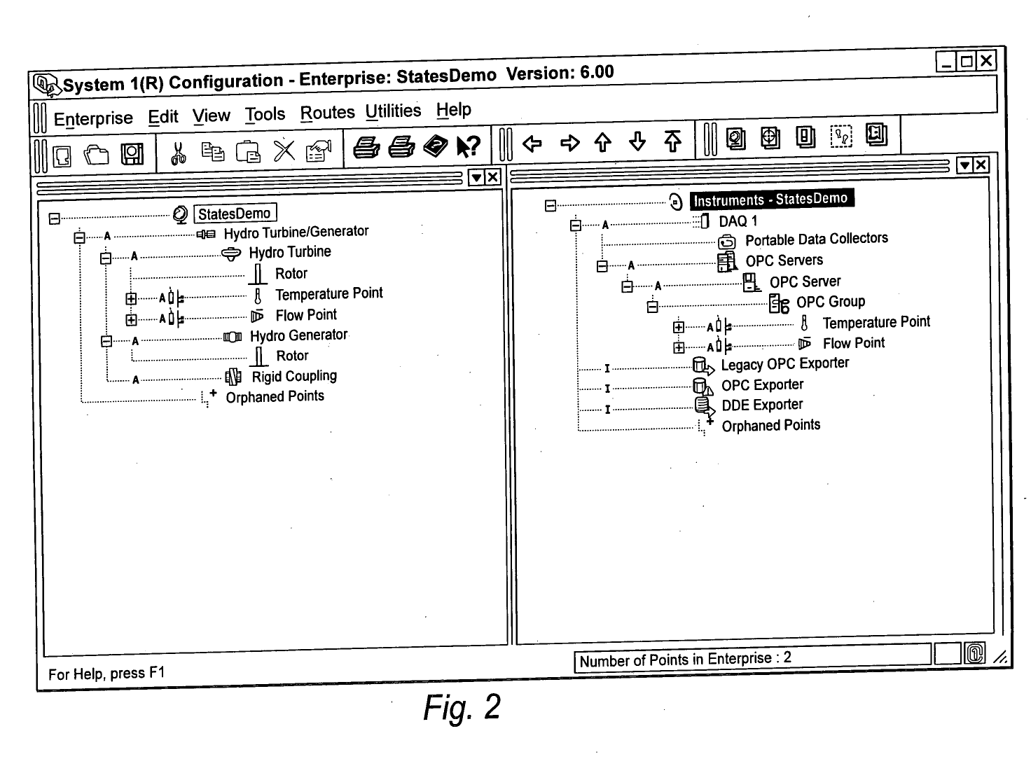

FIG. 2 shows the systems software in operating mode so as to have the plant machinery identified and configured on the left side of FIG. 2 and the data points configured on the right hand side of FIG. 2. The DDE exporter shown in FIG. 2 utilizes the Microsoft protocol “dynamic data exchange” and the OPC exporter utilizes the protocol “OLE for Process Control.” As shown in FIG. 1A and as illustrated in FIG. 2 the first steps involved with respect to the present invention are to configure the machinery, shown on the left hand side of FIG. 2, and to configure the data points, shown on the right hand side of FIG. 2.

Thus, on the left hand side of FIG. 2, the Hydro Turbine/Generator is configured to have a Hydro Turbine and a Hydro Generator. The Hydro Turbine and Hydro Generator are components of a machine train, i.e., the Hydro Turbine/Generator. More particularly, a first node is created corresponding to the “Hydro Turbine/Generator” and three nodes are created there under corresponding to the “Hydro Turbine, Hydro Generator” and “Rigid Coupling.” A further “Rotor” node is created under both the “Hydro Turbine” node and “Hydro Generator” node. Data points, “Temperature Point” and “Flow Point,” associated with the “Hydro Turbine” node are also shown, but are created in accordance the configuration of the data points on the right hand side of FIG. 2, as described below. The “Orphaned Points” node shown on both sides of FIG. 2 contains deleted points during the configuration process.

As shown in the data points configured portion of FIG. 2 the data acquisition points can be obtained from multiple means or devices including portable data collectors and servers. Creation of the data points “Temperature Point” and “Flow Point” from a particular “OPC Group” and “OPC Server,” which in the example of FIG. 2 are associated with the Hydro Turbine of the machine train, also causes their creation on the left hand side of FIG. 2 in association with the Hydro Turbine node.

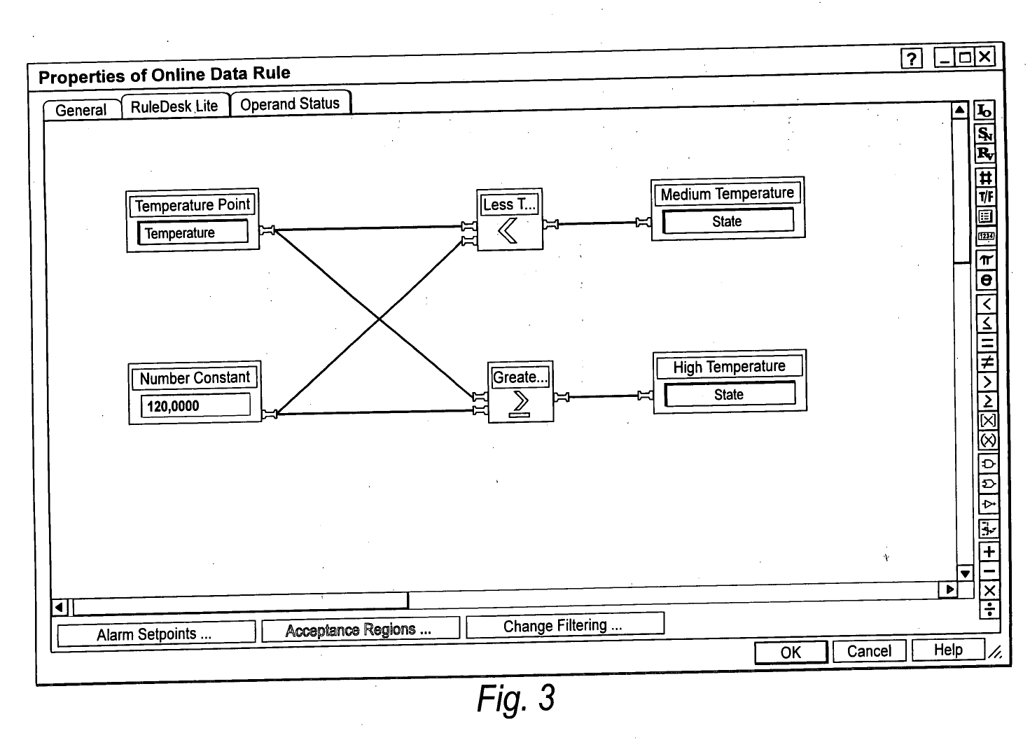

As shown in FIG. 3 the next step is to define the logic for each state using “state qualified variables” (SQVs). These variables are Boolean variables that are used to determine when a state is either in or out of state. As shown in FIG. 3 two state qualified variables are shown with the following logic:
Medium temperature SQV is true when temperature is less than 120; and
High temperature SQV is true when temperature is greater than or equal to 120.
   The logic states are created in the system software by the process described and claimed in U.S. Pat. No. 6,934,696 which is herein incorporated by reference.

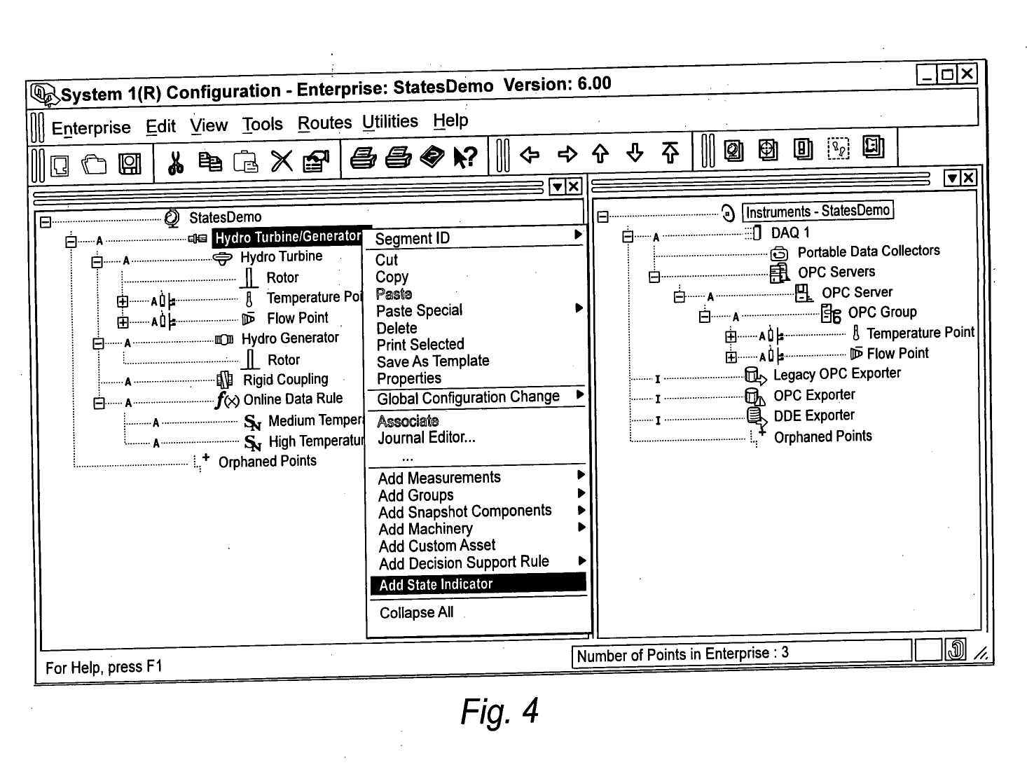

As shown in FIG. 4, once the state qualified variables have been configured (the nodes with the Sn icons next to them) by utilizing the dialog box shown in FIG. 3, then state indicator objects can be added. As shown in FIG. 4, by right clicking on the parent node, i.e., the “Hydro Turbine/Generator” node, the drop down menu is obtained and the “Add State Indicator” selection on the menu can then be highlighted for selection. It should be noted that the state indicator can only be added to the machine train node, i.e., the “Hydro Turbine/Generator” node and not just to either the “Hydro Turbine” or “Hydro Generator” nodes.

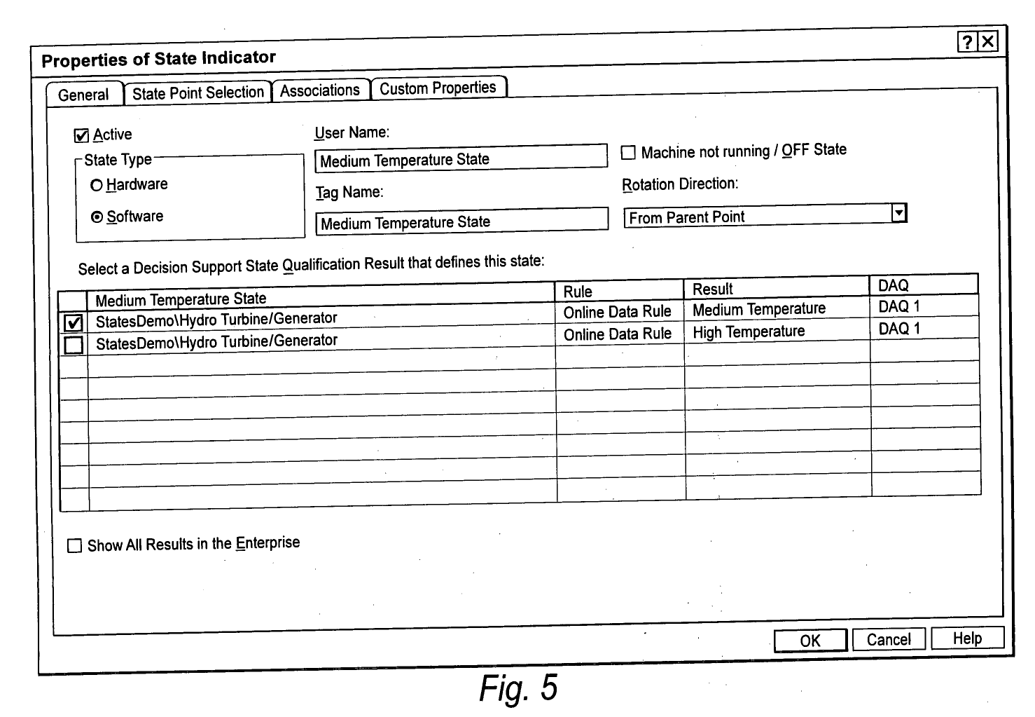

After the selection shown in FIG. 4 the dialog box for the state indicator, shown in FIG. 5, is opened to allow the user to define the name and the association with the state qualified variable. If the user does not want to store any data, then the box labeled “Machine not running/OFF state” should be checked.

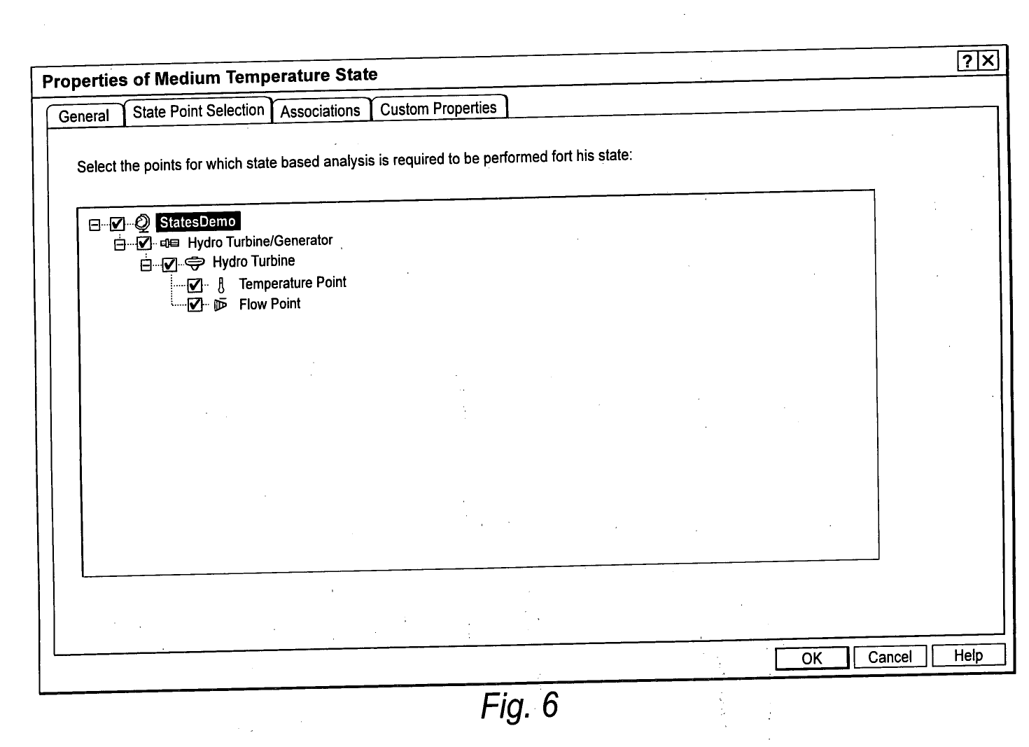

In FIG. 6 the “State Point Selection” tab of the dialog box shown in FIG. 5 has been selected which allows the user to select the points that the user wants to associate with this state, and thereby create state-enabled points.

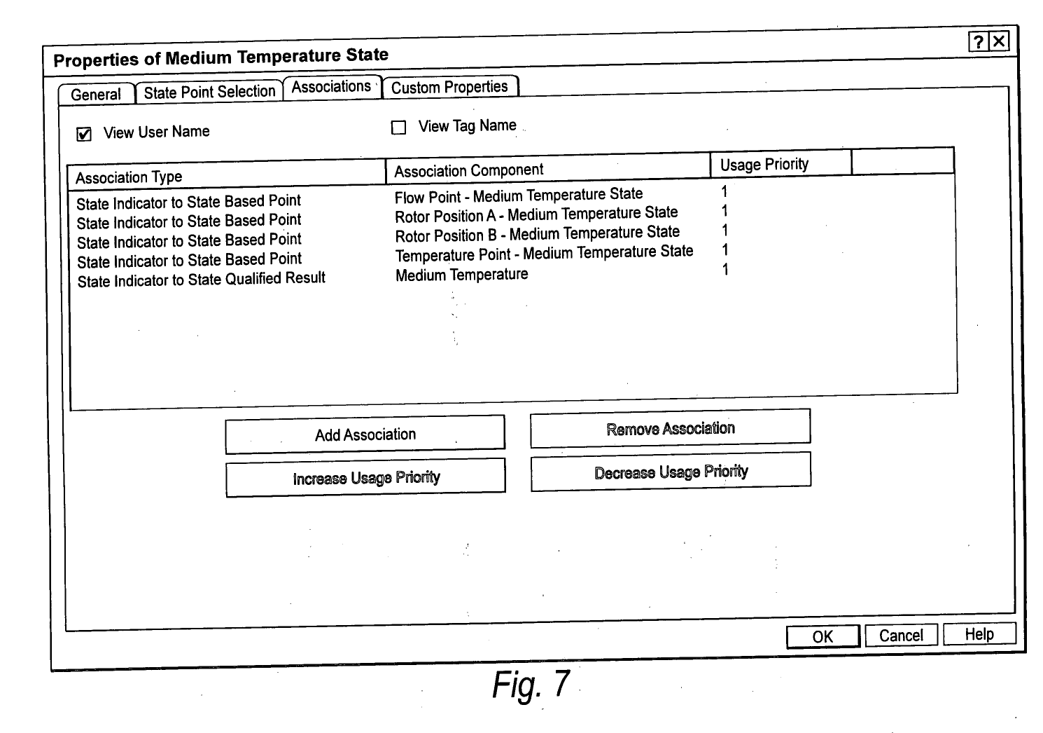

The dialog box shown in FIG. 7 results from the “Associations” tab of FIGS. 5 or 6 having been which allows the user to view, add and remove various associations with other nodes in the configuration trees. This tab is available for all nodes in the configuration hierarchies.

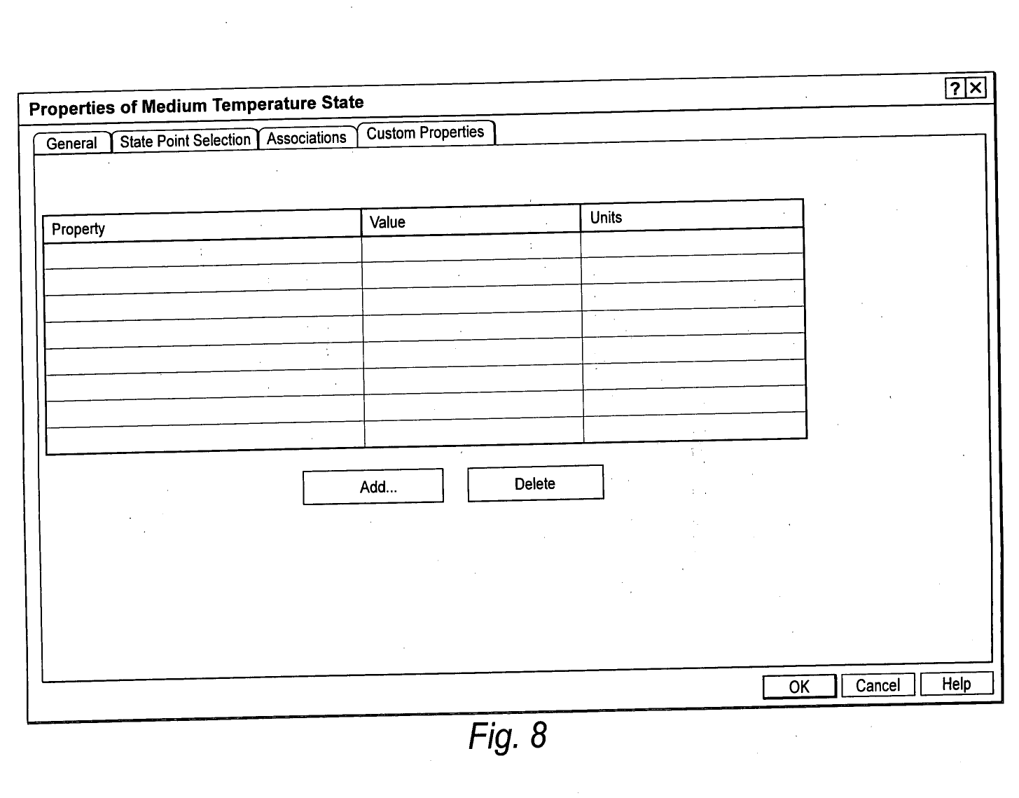

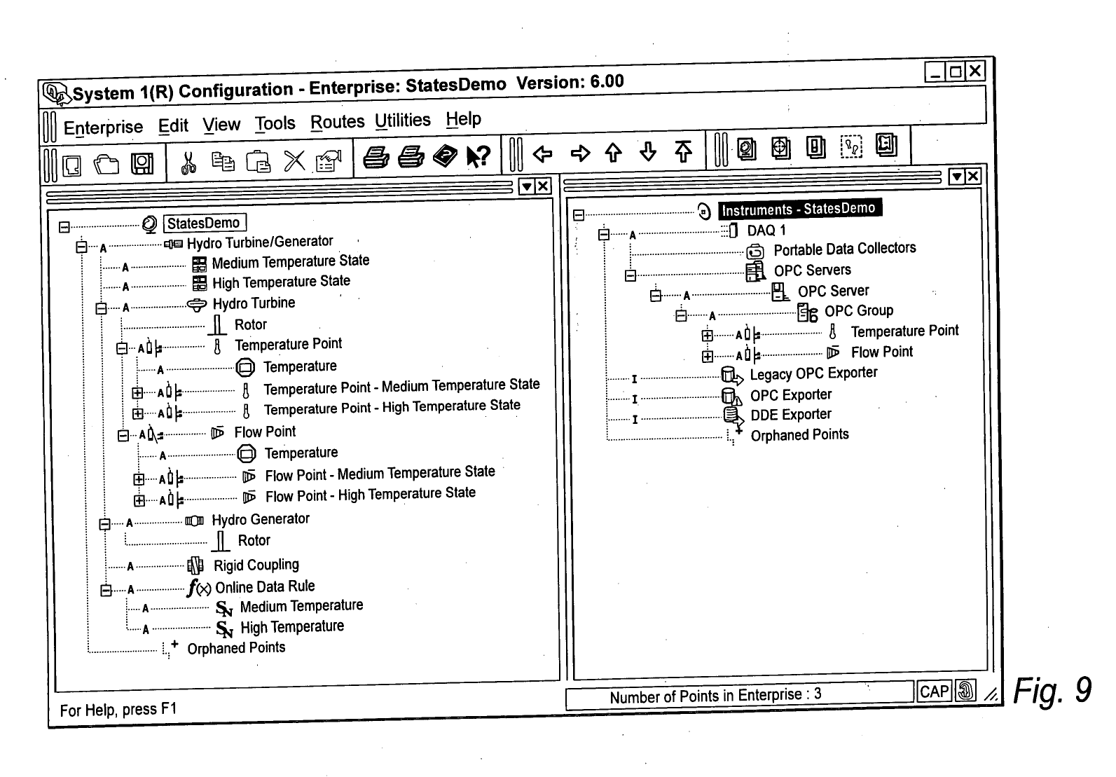

FIG. 8 shows the “Custom Properties” tab of the dialog box of FIG. 5 having been selected which allows the user to create custom user-defined properties. This tab is also available for all nodes in the configuration hierarchies.

FIG. 9 shows a completed sample configuration with state indicator and state-enabled points configured. For example, the “Medium Temperature” and “High Temperature” state indicators and the two state-enabled points under the “Temperature Point” and “Flow Point” are shown in the left pane of FIG. 9.

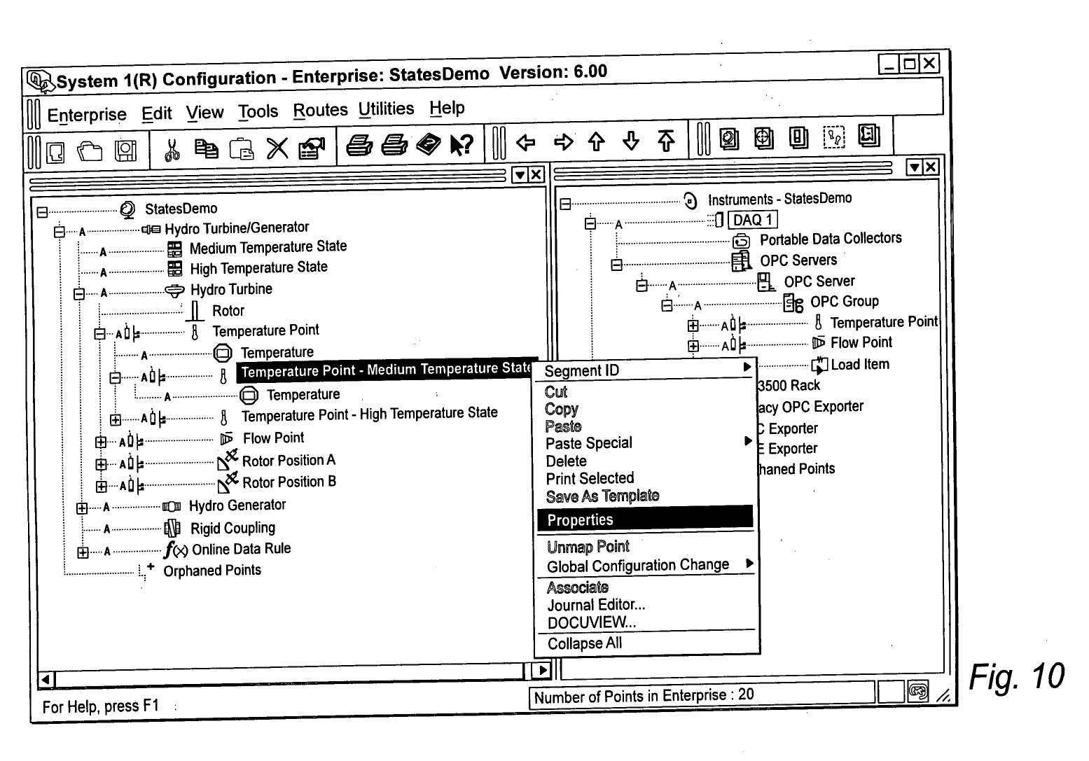

FIG. 10 shows that if a state-enabled point, i.e., the highlighted portion of the left hand pane, is right clicked then a menu pops up which the user can select from. In the menu box shown in FIG. 10 “Properties” has been highlighted in preparation for its selection by clicking on it.

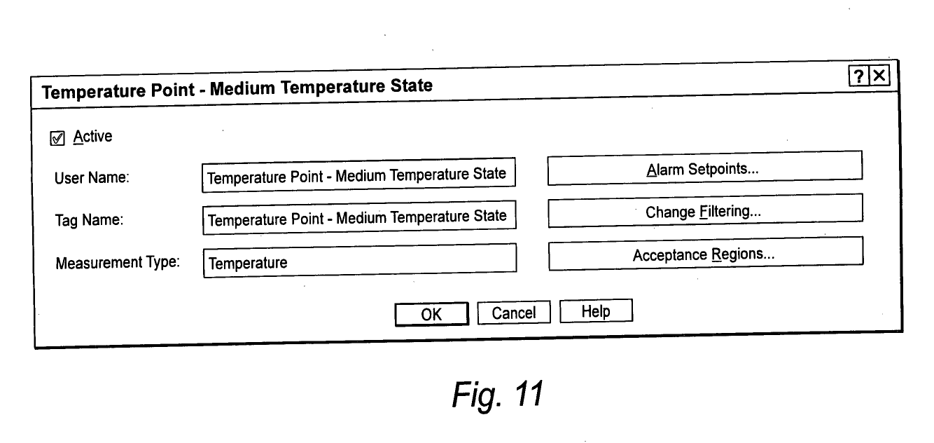

FIG. 11 shows the configuration “Properties” dialog box for state-enabled points which was obtained by right clicking on the “Properties” menu selection shown in FIG. 10. This dialog box allows the user to configure different alarm set points, data storage criteria (i.e., change filtering), and acceptance regions, which are just a different type of set point, for the state-enabled points. These configurations will only be used when the state associated with the state-enabled point is “in state” (i.e., the value of the state is true).

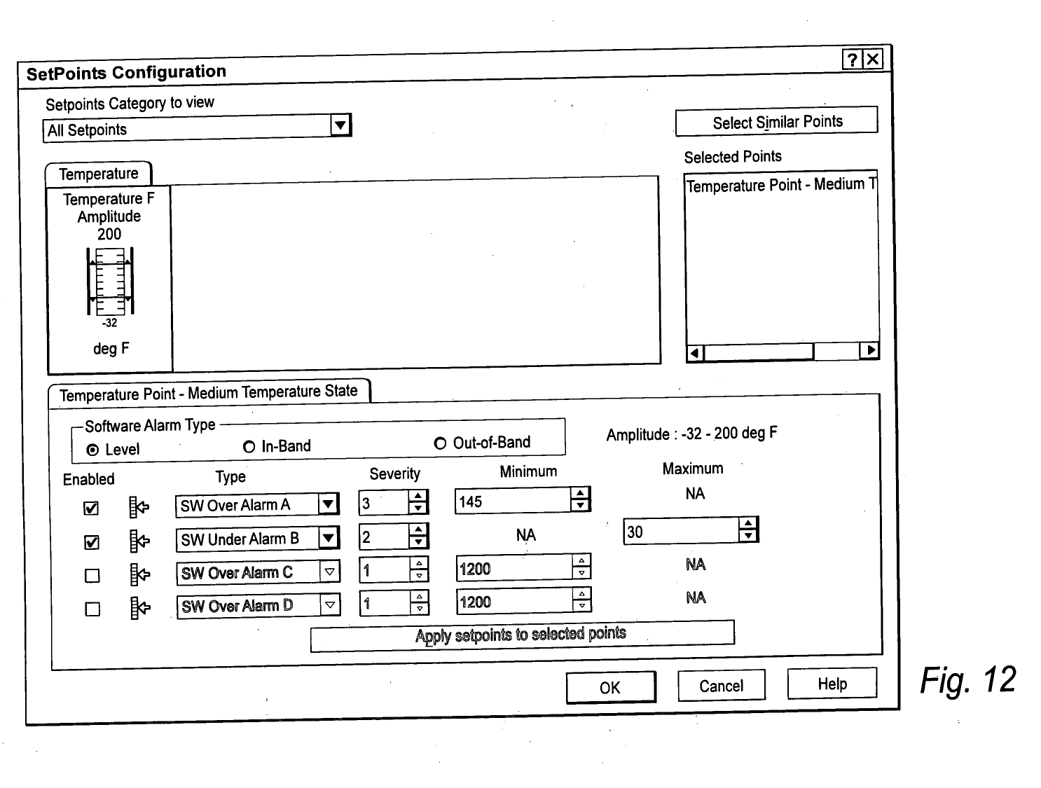

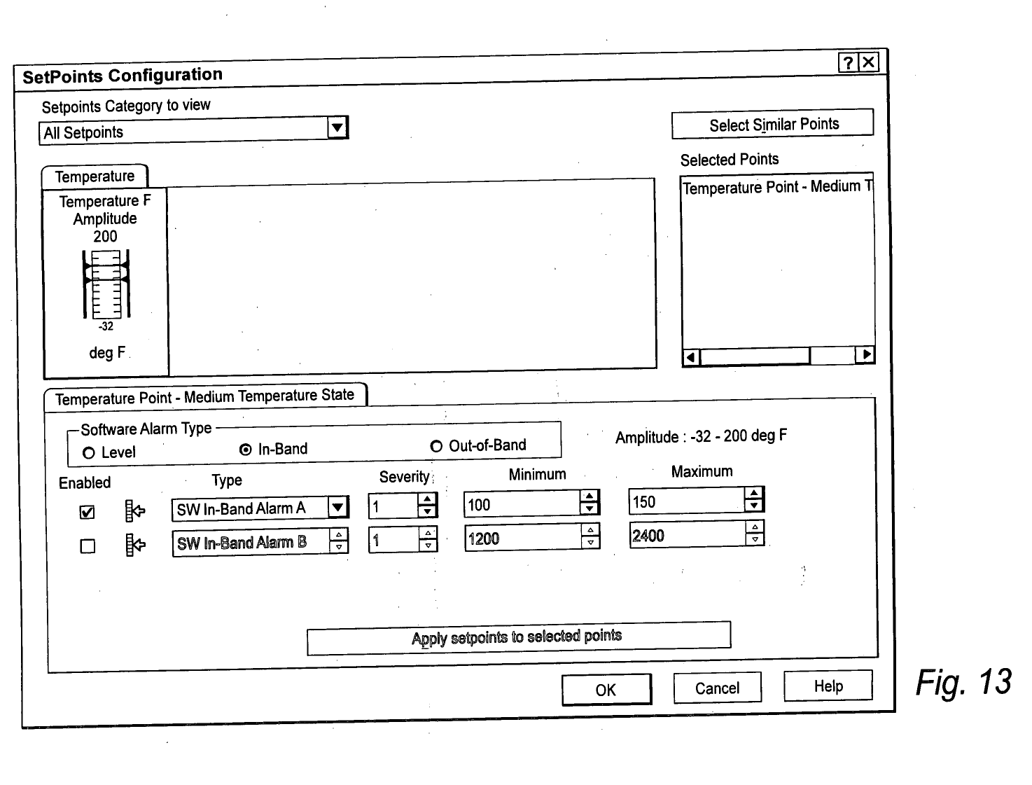

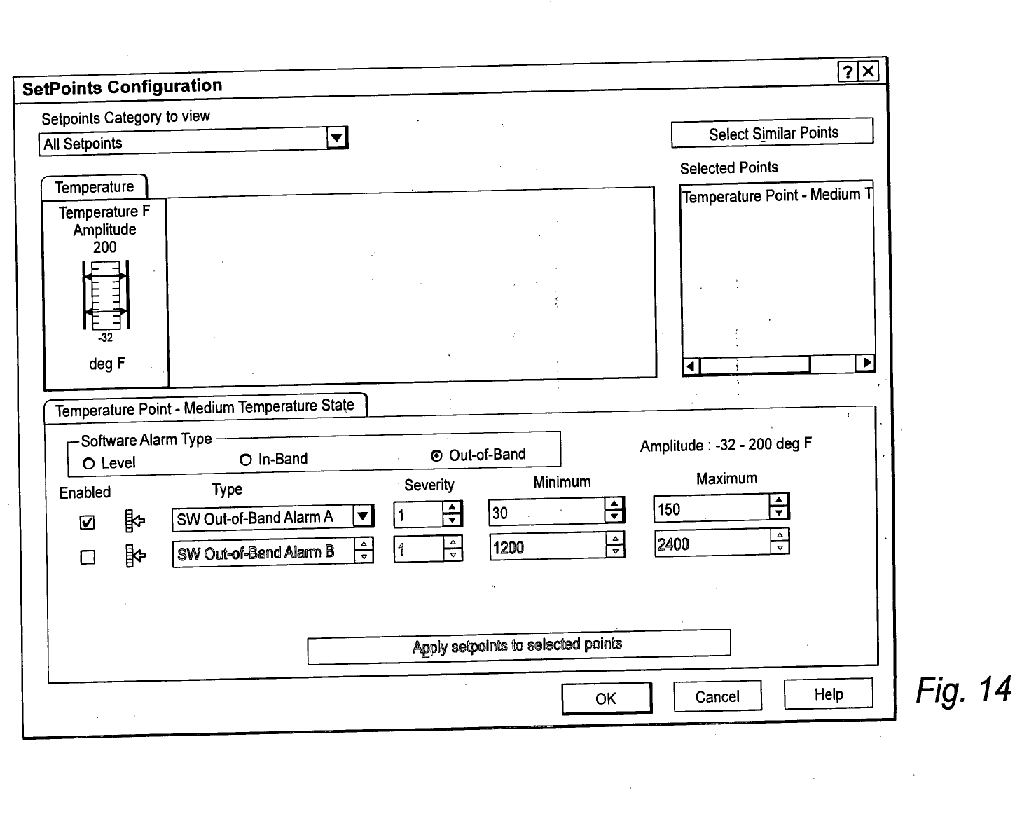

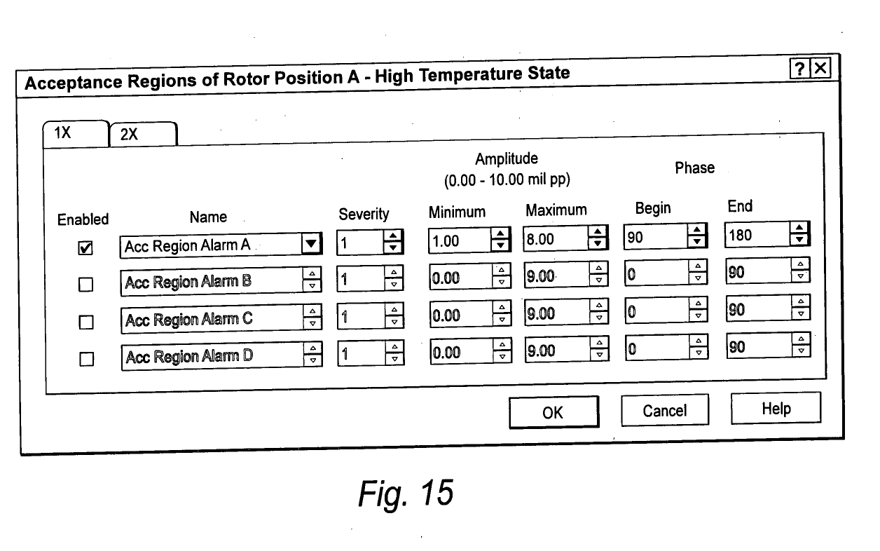

By clicking on the “Alarm Setpoints” button in FIG. 11 the configuration dialog box for configuring level alarm set points, shown in FIG. 12, is obtained. This configuration dialog box is for either the parent point or the child state-enabled points. In FIG. 12 an over alarm of severity 3 is being set and an under alarm of severity 2 is being set by use of the dialog box. Thus, for the alarms being set in FIG. 12, the over alarm set point will go into alarm if the temperature value is above 145° F. and the under alarm set point will go into alarm if the temperature value is below 30° F. FIG. 13, on the other hand, shows an in-band alarm of severity 1 being set. For the alarm being set in FIG. 13, the in-band alarm set point will go into alarm if the temperature value is between 100 and 150° F. The severity can be set, for example, from 0 to 4 with 0 representing not an alarm and 4 representing a high level severity. FIG. 14 shows the configuration dialog box for configuring an out-of-band alarm set point for either the parent point or the child state-enabled point. In this dialog box the severity is also set to 1 and the out-of-band alarm set point will go into alarm if the temperature value is below 30° F. or above 150° F.

FIG. 15 shows the configuration dialog box for configuring an acceptance region set point for either the parent point or the child state-enabled points. This dialog box is activated by pressing the “Acceptance Regions” button in the dialog box shown in FIG. 11. The dialog box in FIG. 15 shows one enabled acceptance region set point configured such that the 1X variable will be in alarm when the 1X amplitude component is outside the range of 1 to 8 mils pp and the phase component is outside the range of 90 to 180°.

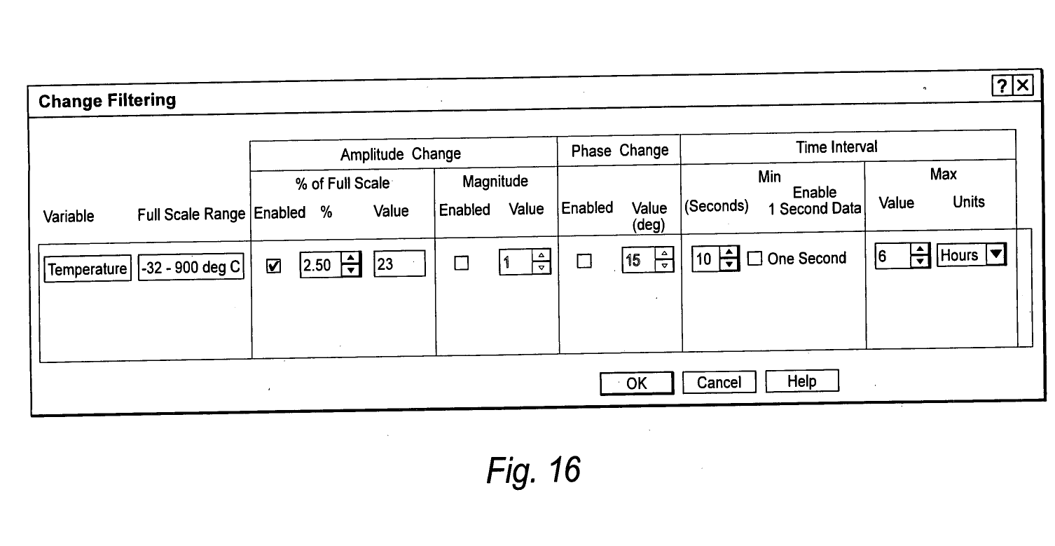

FIG. 16 shows the configuration dialog box for configuring the change filtering data storage parameters for either the parent point or the child state-enabled point. This dialog box is activated by pressing the “Change Filtering” button in the dialog box shown in FIG. 11. These parameters allow the user to define specific conditions when data should be stored, rather than just having the data values stored every X number of seconds.

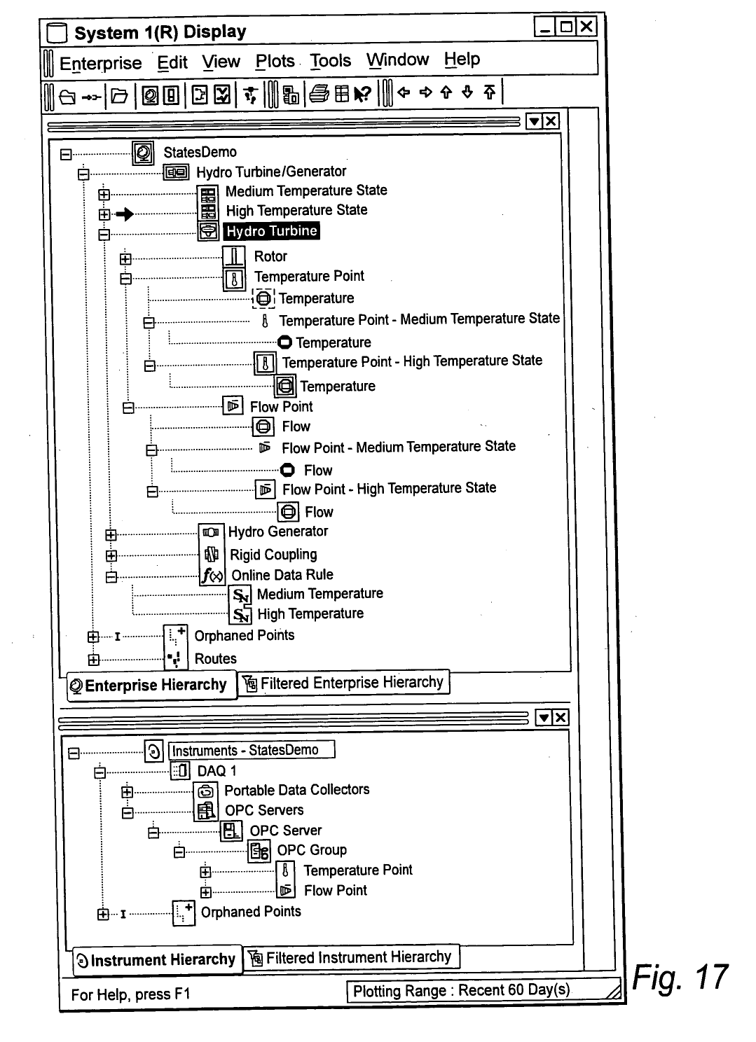

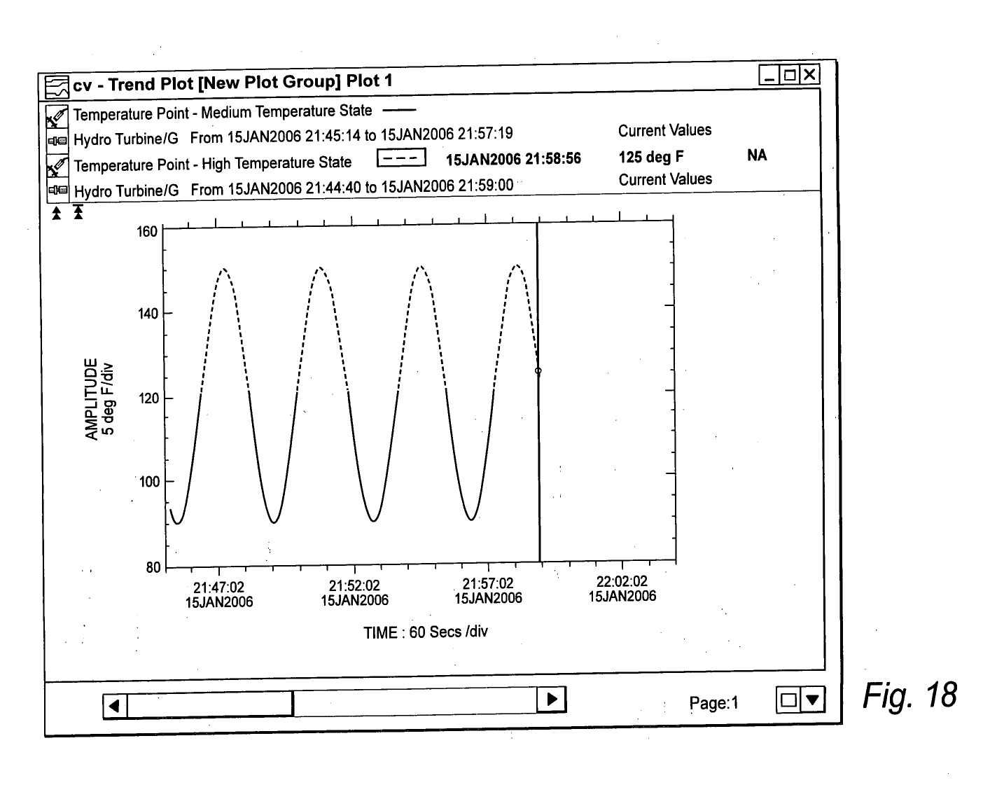

FIG. 17 shows the software display for the Hydro Turbine/Generator machine train in the high temperature state. This is indicated by the icons next to the “High Temperature” state-enabled points being shown with color severity backgrounds, e.g., green, orange, and blue backgrounds. In FIG. 17 the color backgrounds have been coded by the number of lines around the icon. Thus, for example, a level 2 severity alarm can be shown in orange and is indicated in FIG. 17, for example, by the double line boxes around the “Hydro Turbine” and “Temperature Point” icons. In the preferred embodiment, green represents a severity of 0 (no alarm) and is shown by a single box line around the icons, blue represents a severity 1 alarm and is shown by a broken box line around the icons, orange represents a severity 2 alarm, yellow represents a severity 3 alarm (no icons shown in FIG. 17 are in this alarm state) and red represents a severity 4 alarm (no icons shown in FIG. 17 are in this alarm state) which is the highest level of severity with respect to this exemplary system. Also in the preferred embodiment, the state-enabled points that are not “in state” are shown by the icon background being white. This is shown in FIG. 17 with respect to the “Medium Temperature” state-enabled points not being “in state” by having no box lines around the icons. It should be noted that the level 2 severity alarm takes priority over the level 1 alarm and is therefore propagated up the tree. The alarm set points configured for state-enabled points will only be evaluated when the associated state qualified variable is true or “in state.”

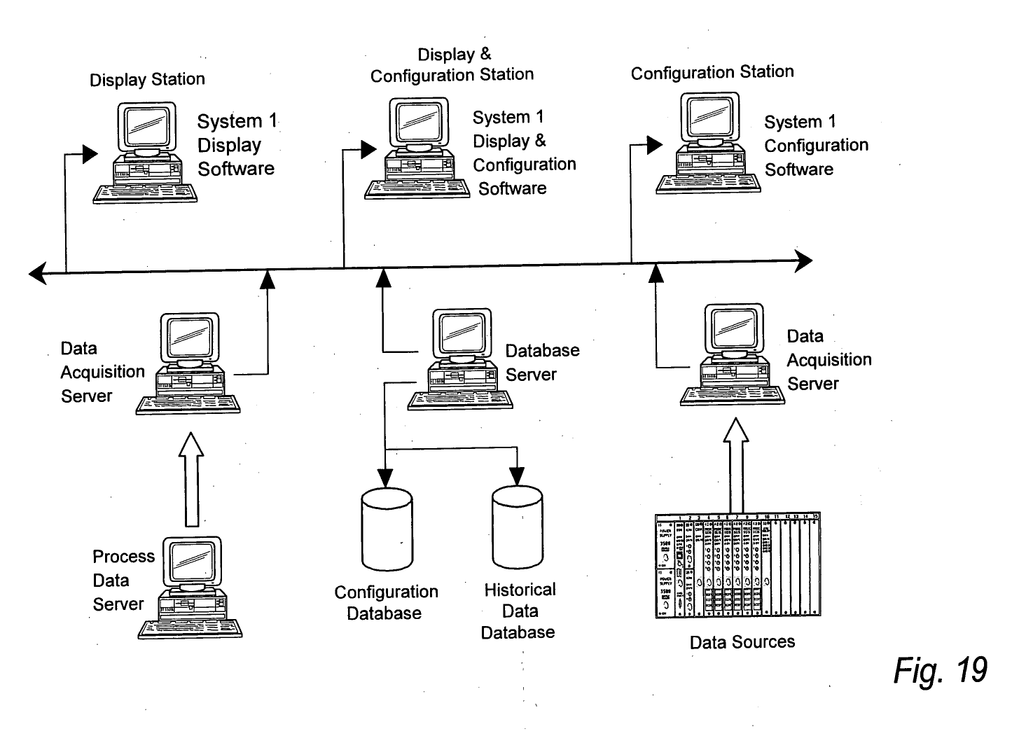

FIG. 18 shows the display software which allows the user to open filtered data plots for the state-enabled point. More particularly, as shown in FIG. 18, a plot for the high and medium temperatures state-enabled points is shown where the high temperature state is true when the temperature value is greater than or equal to 120° and the medium temperature state is true when the temperature value is less than 120°. In the curve shown in FIG. 18 the dashed portion of the curve shows the high temperature state data points and the solid portion of the curve shows the medium temperature state.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A system for configuring, processing and viewing state based data points of a machine, said system comprising:
a programmable processor;
a memory device operatively coupled to said programmable processor;
a display device operatively coupled to said programmable processor;
an input device for accessing said programmable processor and for configuring components of the machine and selectively configuring a plurality of state based data points relating to the components of the machine;
sensors for providing state based data to said programmable processor for each one of said plurality of state based data points;
wherein said programmable processor stores said state based data received from said sensors in said memory device and selectively displays said stored state based data on said display device.

2. The system claimed in claim 1, wherein said input device accesses said programmable processor for setting alarm points for one or more of said plurality of state based data points.

3. The system claimed in claim 1, wherein said programmable processor stores said state based data only for those state base data points of said plurality of state base data points that are in state.

4. The system claimed in claim 1, wherein an online data rule can be configured for each machine state.

5. The system claimed in claim 2, wherein a severity value can be assigned for one or more of said alarm points.

6. The system claimed in claim 5, wherein said display device displays each of said alarm points in accordance with the respective assigned severity value.

7. The system claimed in claim 2, wherein said alarm points can be configured as any one of over, under, in band, out of band, and acceptance region alarms.

8. The system claimed in claim 1, wherein said programmable processor stores said state based data in accordance with specific preset conditions including amplitude change, phase change, and time interval.

9. The system claimed in claim 1, wherein said display device allows a user to display filtered data points of said state based data.

10. The system claimed in claim 1, wherein said programmable processor, said memory device and said display device each comprise separate servers.

11. A method of configuring, processing and viewing state based data points of a machine, said method comprising:
selectively configuring machine components and a plurality of state based data points relating to the machine components;
obtaining state based data for each one of said plurality of state based data points;
storing said obtained state based data in a memory device; and
selectively displaying said stored state based data.

12. The method claimed in claim 11, further including setting alarm points for one or more of said plurality of state based data points.

13. The method claimed in claim 11, wherein data is stored only for state based data points of said plurality of state based data points that are in state.

14. The method claimed in claim 11, further including configuration of an online data rule for machine state.

15. The method claimed in claim 12, further including setting a severity value for one or more of said alarm points.

16. The method claimed in claim 15, further including displaying said alarm points in accordance with the respective assigned severity value.

17. The method claimed in claim 12, wherein said alarm points can be configured as any one of over, under, in band, out of band, and acceptance region alarms.

18. The method claimed in claim 11, further including storing said state based data in accordance with specific preset conditions including amplitude change, phase change, and time interval.

19. The method claimed in claim 11, further including displaying filtered data points of said state based data.
